(19) United States
(12) Patent Application Publication
(10) Pub. No.: US 2007/0050586 A1
(43) Pub. Date: Mar. 1, 2007

(54) Memory access control apparatus

(75) Inventors: Hiromasa Shin, Yokohama-shi (JP); Shigeta Kuninobu, Kawasaki-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/509,596

(22) Filed: Aug. 25, 2006

(30) Foreign Application Priority Data
Aug. 26, 2005 (JP) 2005-246326

(51) Int. Cl. G06F 12/14

(52) U.S. Cl. 711/163

(57) ABSTRACT

In a region switching table, address regions covering a memory space are defined, and operations which can access the regions in domains corresponding to components of a program are listed. A domain number which indicates a domain corresponding to a component of the program under execution, and a region number which indicates a region including an address which is accessed immediately before are held in respective registers. The apparatus includes an access check unit which issues a first interruption, if the processor request address (VA) falls outside a region boundary. The access check unit also issues a second interruption, if the processor request operation code (OP) is not permitted according to a permission attribute corresponding to the domain number of the region including the processor request address (VA). The access check unit writes interrupt factors in a register, if the first interruption or the second interruption has been occurred.

### CROSS-REFERENCE TO RELATED APPLICATIONS

This application is based upon and claims the benefit of priority from prior Japanese Patent Application No. 2005-246326, filed Aug. 26, 2005, the entire contents of which are incorporated herein by reference.

### BACKGROUND OF THE INVENTION

1. Field of the Invention

The present invention relates to a memory access control apparatus.

2. Description of the Related Art

A computer such as a CPU provides a memory space in which flat addressing (in which, for example, a single integer designates a unique location of memory space) can be performed with respect to a program. Using a memory space which allows flat addressing makes it possible to share a method of constructing a data structure using pointers (i.e., variables that store memory addresses; a method of abstracting memory addresses by using a program language) or data which require no copying operation, thereby generating a highly efficient program. If, however, a defective or malicious code exists in part of a program, the reliability of the overall program deteriorates.

A large-scale program demanding high reliability is generated by associating a plurality of program components (constituent elements in this case). A program is generated such that the respective program components have clearly defined public interfaces and link with each other, and access regions of a memory and subroutine calls between the respective program components are limited in necessary ranges.

When predetermined limitations are imposed on memory access and subroutine call for each program component in this manner, even if a defective or malicious code exists in a program component, the influence of the code can be suppressed within a predetermined range. This makes it possible to improve the reliability of the overall program.

With regard to memory access for each program component, a permission map in which accessible address areas and the respective operation types are defined is generated. Access limitation is performed by referring to this permission map. The memory areas written in this permission map are scattered in the address space of a storage device, and addresses indicating the starts and ends of the memory areas are not always aligned at each page boundary. In addition, if the program is changed and a program component is replaced with a new one, the permission map need to be greatly changed accordingly.

Access control methods using such a permission map include a conventional MMU (Memory Management Unit) scheme, ABR (Address Boundary Register) scheme, and mixed scheme.

In the MMU scheme, access limitation is performed on a page basis by providing permission bits for page table entries managed by a memory management unit. A page (is typically 4 Kbytes) as an access control unit is large enough to the protection unit for software objects, like variables or subroutines. When protection targets in the program are sorted along page boundaries, fragmentation occurs in pages, resulting in a deterioration in the use efficiency of the memory. In general, permission bits to be stored in the page table entries are limited to a small number of sets, and hence permission maps corresponding to a program component under execution cannot be efficiently multiplexed.

In the ABR scheme, the range of accessible addresses values is limited by providing an address boundary register or segment descriptor which designates the upper and lower limits of an accessible area. Although the location and size of an access control unit can be arbitrarily defined, the number of memory areas which can be simultaneously designated is limited by the number of address boundary registers.

In the mixed scheme, several sets of information including combinations of upper and lower limit addresses, permission bits, and priorities are simultaneously defined, and access control is performed on the basis of the permission bit in a highest priority range including a request address. An address range is designated either by a scheme using the upper bit sequence of an address or by a scheme using an address boundary register described in U.S. Pat. No. 7,068,545. In these schemes, when an address range is designated by the upper bit string of an address, strong limitations are imposed on the size and location of an address range. In this case, the strong limitations indicate that an address range which can be designated is limited to a power of 2 size, and the address of the range is limited to a multiple of the size.

According to such methods, it is impossible to efficiently limit an access memory area for each program component without changing any program code.

### BRIEF SUMMARY OF THE INVENTION

According to one aspect of the present invention, there is provided a memory access control apparatus comprising a first storage to store a region switching table in which a plurality of address regions covering a memory space are defined, and operations which can access the regions in a plurality of domains corresponding to components of a program are listed; a first register to hold an interrupt factor; a second register to hold a domain number which indicates a domain corresponding to a component of the program under execution; a third register to hold a region number which indicates a region including an address which is accessed immediately before; and an access check unit configured to: receive a processor request address (VA), a processor request operation code (OP), the domain number, and the region number, issue a first interruption, if the processor request address (VA) falls outside a region boundary which is specified by the region number in the region switching table, issue a second interruption, if the processor request operation code (OP) is not permitted according to a permission attribute corresponding to the domain number of the region including the processor request address (VA), and writes a first interrupt factor including the processor request address (VA) and a second interrupt factor including the processor request operation code (OP) in the first register, if the first interruption or the second interruption has been occurred.

### BRIEF DESCRIPTION OF THE SEVERAL VIEWS OF THE DRAWING

FIG. 1 is a block diagram showing a computer system including an access control apparatus according to an embodiment;

FIG. 2 is a functional block diagram showing the access control apparatus;

FIG. 3 is a view showing the control register of an access check unit;

FIG. 4 is a view showing a region switching table and a domain switching table;

FIG. 5 is a view showing an example of how the region switching table and the domain switching table are encoded;

FIG. 6 is a flowchart for an access check unit initialization device;

FIG. 7 is a flowchart showing the flow of operation of the access check unit;

FIG. 8 is a flowchart for a region switching device;

FIG. 9 is a flowchart for a domain switching device;

FIG. 10 is a view showing the access check unit; and

FIG. 11 is a flowchart showing the operation of starting, suspending, and terminating a program.

### DETAILED DESCRIPTION OF THE INVENTION

Embodiments of the present invention will be described below with reference to the views of the accompanying drawing.

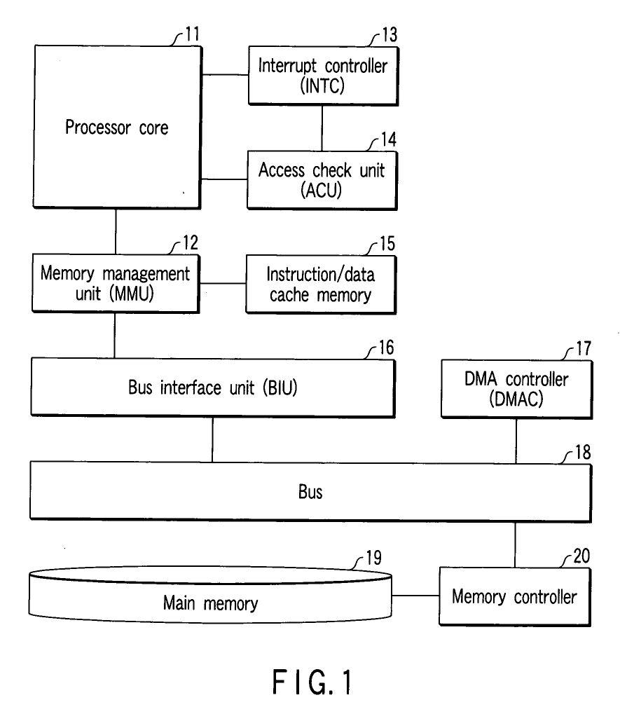

A case wherein an access control apparatus according to an embodiment is provided in a computer system will be briefly described first with reference to FIG. 1.

As depicted in FIG. 1, this computer system includes a processor core 11 which performs main calculation, a main memory 19 for recording information, an interrupt controller 13 (INTC) which controls interruption to the processor core 11, a memory management unit 12 (MMU) for managing the operation of the main memory 19, an instruction/data cache memory 15, a bus interface unit 16 (BIU) for connecting the processor to a bus 18, a memory controller 20 for connecting the main memory 19 to the bus 18, and an access check unit 14 (ACU) which connects to the processor core 11 and the interrupt controller 13 and performs access control in accordance with a program under execution. The memory system includes elements on a path from the processor core 11 to the main memory 19, and is hierarchically constituted by the memory management unit 12, instruction/data cache memory 15, memory controller 20, main memory 19, and the like. The access check unit 14 is located between the processor core 11 and the memory system and monitors access to the memory system of the processor core 11. More specifically, the processor core 11 receives a request to access the memory system and an operation code, and refers to access control information concerning the program under execution. When the program issues an access request to the memory system, the access is permitted or inhibited.

The access control apparatus according to the embodiment is placed on the access check unit 14 and main memory 19 shown in FIG. 1.

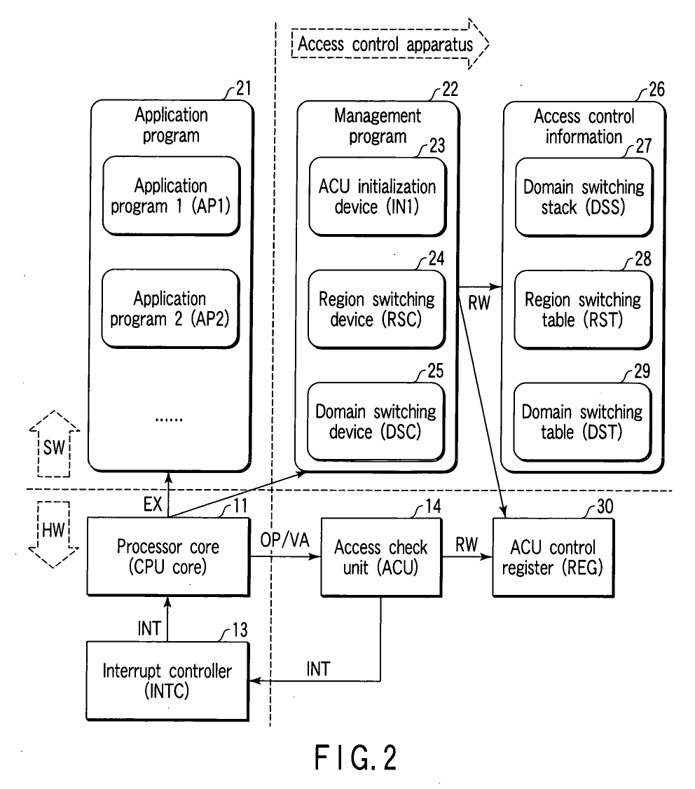

As shown in FIG. 2, this access control apparatus includes the access check unit 14 (ACU), an ACU control register 30 (REG), an ACU initialization device 23 (INI), a region switching device 24 (RSC), and a domain switching device 25 (DSC). The main memory 19 includes a domain switching stack 27 (DSS), region switching table 28 (RST), and domain switching table 29 (DST). Note that a management program 22 includes the blocks 23, 24, and 25. Access control information 26 includes the blocks 27, 28, and 29. The access control information includes the region switching table 28 and domain switching table 29 of the access control information 26.

In this access control apparatus, the ACU initialization device 23 (INI) stores the access control tables (28 and 29) which reflect the structure of an application program 21 as a protection target in the main memory 19 before the execution of the program. The access control apparatus then stores the region switching table 28 (RST) in the ACU control register (REG), and starts the application program 21. The access check unit 14 then monitors memory access of the application program 21 by referring to the region switching table 28 (RST). Upon detection of an abnormality, the access check unit 14 generates an interrupt to the processor core 11, and transfers control to the management program (the region switching device 24 and the domain switching device 25). The region switching device 24 (RSC) and the domain switching device 25 (DSC) set and switch permission maps independently of the application program 21.

Changing the contents written in the access control table in this manner makes it possible to perform tuning in consideration of the tradeoff between reliability and performance.

If spatial locality exists in an address which a program under execution requires, a function (the devices 24 and 25, to be specific) of decreasing the use frequency of the access control apparatus is implemented by software. This can reduce the cost and power consumption of the processor core 11 without greatly degrading the performance.

In this case, the access control table includes a permission map for permitting a program to access the memory and data which defines switching permission information which switches areas of the memory to which a program accesses, or the access control table comprises a region switching table and a domain switching table.

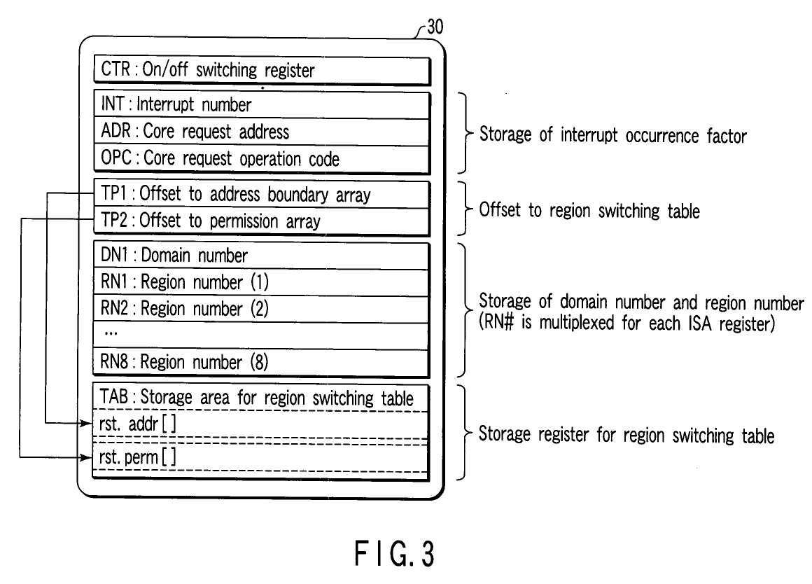

As indicated by an arrow 31 in FIG. 2, a signal representing a request code and request address is input from the processor core 11 to the access check unit 14 in synchronism with a CPU clock. The ACU control register 30 inputs a region number (RN# in FIG. 3), a domain number (DN1 in FIG. 3), and the region switching table 28 (TAB in FIG. 3) to the access check unit 14 (ACU). Upon detecting an abnormality in memory access from an application program, the access check unit 14 transmits an exception to the processor core 11. When an exception occurs, the access check unit stores an exception code (INT in FIG. 3), a core request code at the time of the occurrence of the exception (OPC in FIG. 3), and a core request address (ADR in FIG. 3) in the register 30. An operation request code includes three components, i.e., a memory operation type (R|W|X), a control transfer factor (call|retn|othr), and an access register number at the time of an access request. The memory operation type is memory read (R), memory write (W), or instruction read (X). The control transfer factor is subroutine call (call), procedure return (retn), or other (othr).

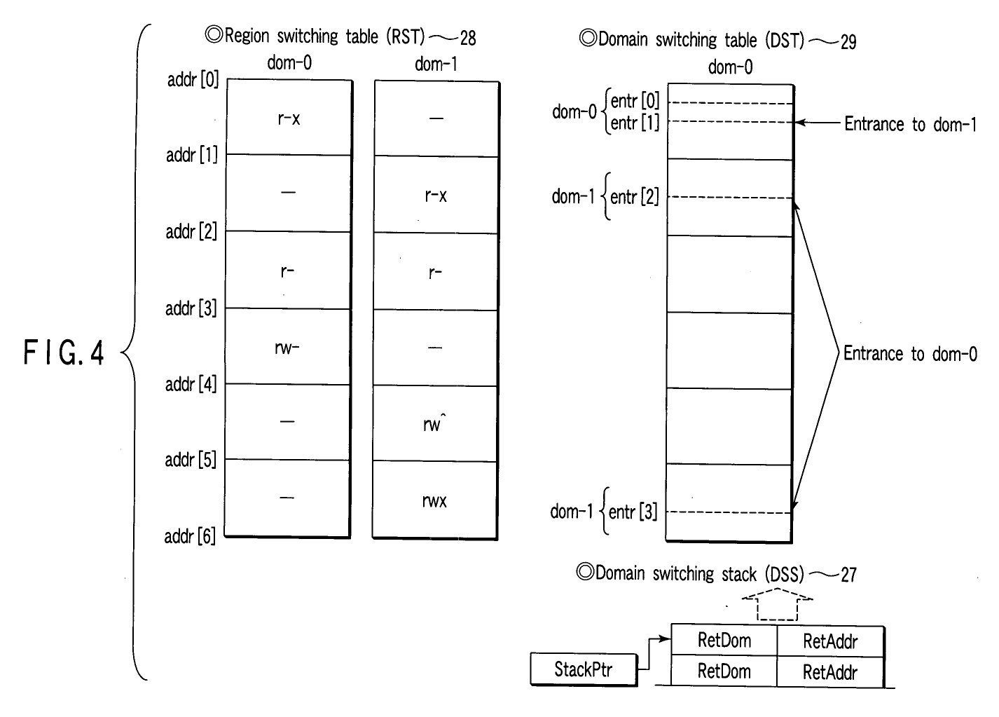

Upon receiving an interrupt from the access check unit 14, the processor core 11 suspends the execution of the application program 21, and starts the region switching device 24 or domain switching device 25 of the software implementation (implementable) unit 22 registered in advance. The region switching device 24 reads in an interrupt factor from the ACU control register 30, and updates the region number (RN# in FIG. 3) by referring to the region switching table 28. The domain switching device 25 reads in an interrupt factor from the ACU control register 30, and updates the domain number (DN1 in FIG. 3) by referring to the domain switching table 29 (FIG. 4) and the domain switching stack 27 (FIG. 4). The domain switching device 25 sometimes detects an access violation (INT3) against the memory or a domain switching violation (INT4). When the management program (the region switching device 24 or the domain switching device 25) terminates without detecting any violation, the processor core 11 resumes the application program from the instruction in which the exception has occurred.

The access control apparatus according to the embodiment uses a method of limiting access to the memory which is requested by the processor core 11 during the execution of the program, and determines permission/inhibition of access from a program by referring to the access control tables and the control register using both the access control tables 28 and 29 (FIG. 4) corresponding to the static structure of the program, and the ACU control register 30 and the domain switching stack 27 corresponding to the dynamic state of the program.

In the access control apparatus according to the embodiment, with regards to the arrangement and placement of the access control table, the table is separated into the region switching table 28 in which a permission map for each program component is described and the domain switching table 29 in which the relationship in control transfer between program components is described, and the region switching table 28 which is frequently accessed is placed in the ACU control register 30 (REG), thereby realizing an increase in speed and an improvement in reliability.

The region switching table 28 (RST), domain switching table 29 (DST), and domain switching stack 27 (DSS) of the embodiment will be described next with reference to FIG. 4.

As shown in FIG. 4, the region switching table 28 (DSS) of the embodiment is expressed by addresses in the row direction and domains in the column direction. In this case, an instruction area (“r-x”, e.g., 0x5) ranges from address rst.addr[0] to address rst.addr[1] in domain dom-0, an access inhibition area (“---”, e.g., 0x0) ranges from address rst.addr[1] to address rst.addr[2] in domain dom-0, a read-only area (“r--”, e.g., 0x1) ranges from address rst.addr[2] to address rst.addr[3] in domain dom-0, a read/write area (“rw-”, e.g., 0x3) ranges from address rst.addr[3] to address rst.addr[4] in domain dom-0, and an access inhibition area (“---”, e.g., 0x0) ranges from address rst.addr[4] to address rst.addr[5] in domain dom-0. An access inhibition area (“---”, e.g., 0x0) also ranges from address rst.addr[5] to the subsequent address in domain dom-0. In addition, an access inhibition area (“---”, e.g., 0x0) ranges from address rst.addr[0] to address rst.addr[1] in domain dom-1, an instruction area (“r-x”, e.g., 0x5) ranges from address rst.addr[1] to address rst.addr[2] in domain dom-1, a read-only area (“r--”, e.g., 0x1) ranges from address rst.addr[2] to address rst.addr[3] in domain dom-1, an access inhibition area (“---”, e.g., 0x0) ranges from address rst.addr[3] to address rst.addr[4] in domain dom-1, a read/write area (“rw-”, e.g., 0x3) ranges from address rst.addr[4] to address rst.addr[5] in domain dom-1, and an all access permission area (“rwx”, e.g., 0x7) ranges from address rst.addr[5] to the subsequent address in domain dom-1.

The domain switching table 29 (DST) indicates the locations of entrance dst.addr[0], dst.addr[1], dst.addr[2], and dst.addr[3] of domain dom-0 and domain dom-1. The domain switching stack 27 (DSS) has the arrangement shown in FIG. 4.

A logical unit called a protective domain is defined, and an executable code of a program is assigned to one of the protective domains. A common access permission map is used for executable codes assigned to the same protective domain. The range in which the influence of this portion reaches if a defective or malicious portion exists in an executable code becomes a protective domain.

Although a protective domain is assumed to be assigned to each component of a program, one protective domain can be assigned to a plurality of components associated with each other (corresponding to the same manufacturer). A program has a plurality of domains, and defects existing in a program component are isolated in the respective domains. Assume that a protective domain is uniquely identified by a number, and this identifier will be referred to as a domain number hereinafter.

Addresses with a common allowed attribute among all the protective domains of the program are grouped into the same cluster, and the respective addresses are classified into clusters. Thereafter, a maximum range in which consecutive address values belong to the same cluster is called a protective region. Expressing a region switching table according to this definition makes it possible to guarantee the region atomicity.

According to the definition, a set of all regions covers the entire address space without overlapping. Providing a protective domain and a request address will determine operation that can be applied to an address range. Each region can be uniquely (one to one) identified by using an address, and this identifier will be refereed to as a region number hereinafter.

The ACU control register 30 (REG) which controls the operation of the access check unit 14 (ACU) will be described next with reference to FIG. 3.

A control register (CTR) is a register which designates the presence/absence of an access check, and is used to switch on/off an access check from the processor core 11. When the access check unit 14 detects an exception and starts an exception handler, the access check unit 14 switches the value of the control register (CTR) from ON to OFF.

A request address register (ADR) is a register which records an address requested by the processor core 11 at the time of the occurrence of an exception. The access check unit 14 writes such an address in this register. The processor core 11 which is executing the management program 22 reads out the address.

A request operation code register (OPC) is a register which records an operation code requested by the processor core 11 at the time of the occurrence of an exception. The access check unit 14 writes such a code in this register. The processor core 11 which is executing the management program 22 reads out the code.

The value of the operation request code register (OPC) includes three components, i.e., a memory operation type (opc[0]::=R|W|X), a control transfer factor (opc[1]::=call|retn|othr), and an address register number (opc[2]) at the time of the generation of the access request. The memory operation type is memory read (R), memory write (W), or instruction read (X). The control transfer factor is a subroutine call (call), procedure return (retn), or other (othr).

An exception code register (INT) is updated by the access check unit 14 at the time of the detection of an exception. The processor core 11 refers to this register during the execution of an exception processing code. Exception codes include a region switching exception (INT1) and a domain switching exception (INT2).

An address boundary array database (TP1) is a register which holds an ACU control register number at the head of an address array (rst.addr[]) in the region switching table, and there is no need to change the register value while the same application program is executed.

A permission array database (TP2) is a register which holds an ACU control register number at the head of a permission array (rst.perm[]) in the region switching table, and there is no need to change the register value while the same application program is executed.

A domain number register (DN1) holds a domain number for identifying a protective domain during the execution of an application program. When a protective domain changes, the domain switching device 25 (to be described later) updates the domain number register.

A region number register (RN#) holds a region number corresponding to the region including an address, which is accessed immediately before, so as to make a pair with an address register of the processor core 11. When the address changes to one outside the region, the region switching device 24 (to be described later) updates the region number register. When spatial locality exists in memory access, the number of executions by the region switching device 24 can be reduced by multiplexing region number registers for each address register.

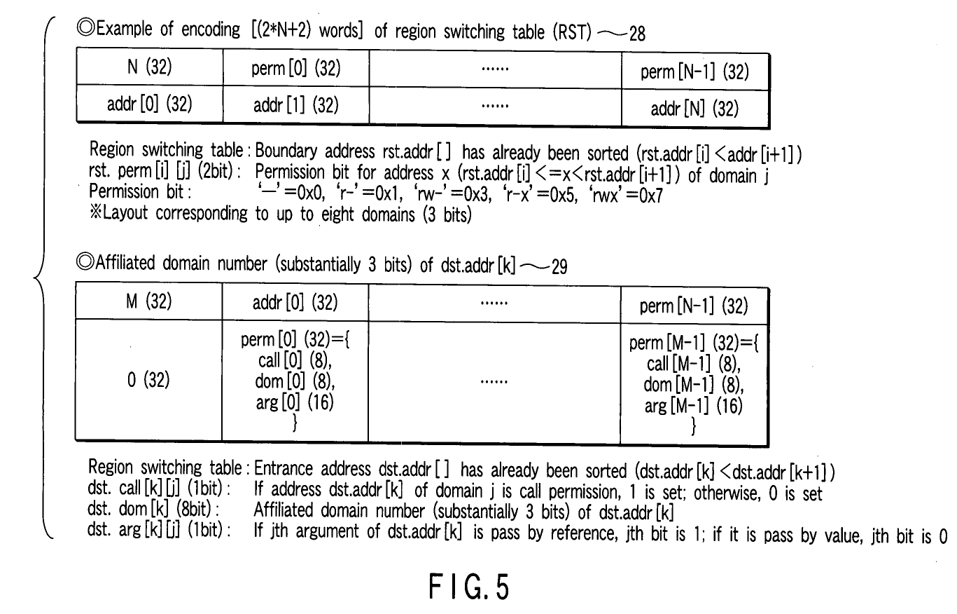

“RST” in FIG. 5 shows an example of encoding of the region switching table 28. A plurality of address regions covering a flat memory space are defined, and operations which can access the memory areas in the respective domains are listed. A region switching table comprises a boundary address array rst.addr[] and a permission bit map array rst.perm[]. As the start word of a region table area, a size N of the table is recorded. In address array rst.addr[], region boundary addresses are sorted and stored in the order of address values, and the lower limit (0x00000000 in the case of a 32-bit address) and lower limit (0xffffffff in the case of a 32-bit address) of an address space are stored as the elements defined by start rst.addr[0] and end rst.addr[M] of the array. A region with a region number i is assumed to be an address area defined by rst.addr[i] or more and less than rst.addr[i+1]. Note that the symbol “x.y[z]” used in this case is assumed to be “the zth component when a component with a name y is acquired from a variable x, and acquired y is regarded as an array”.

In bitmap array rst.perm[], a permission attribute with a region number i is stored as ith element rst.perm[i] in a bitmap format, and a permission attribute with respect to a domain number j is stored as jth slot rst.perm[i][j] of the same bitmap. In this example of encoding, each slot comprises four bits, and domains can be written up to eight.

FIG. 5 shows an example of encoding of the domain switching table DST. The domain switching table comprises address array dst.addr[] and bitmap array dst.perm[]. As the start word of a domain switching table area, a size M of the table is stored. In address array dst.addr[], a list of addresses indicating the entrances of protective domains is sorted and stored in the order of addresses. Components dst.perm[k].dom and dst.perm[k].call hold the affiliated domain number of entry point dst.addr[k] and a bitmap indicating whether a call from another domain is permitted or inhibited at the kth element.

In general, the entry point of a protective domain is an interface function address (the start address of an application programming interface) which is disclosed to the outside by a program component.

It is assumed that the processor core 11 has a privileged mode of executing the management program 22 in addition to a user mode of executing the application program 21, the region switching device 24 and domain switching device 25 execute operation in the privileged mode, and no check is performed on access to the memory in the privileged mode. When the access check unit 14 generates a fault, the processor core 11 suspends the execution of the application program 21, switches the execution mode from the user mode to the privileged mode, and starts a management program registered in advance as an exception handler.

Since an exception handler to be registered in this processor is the region switching device 24 or domain switching device 25 itself, the management programs 22 are assumed to be management programs to be activated in accordance with a fault type. Access check in the above privileged mode can be suspended by turning off the above control register CTR.

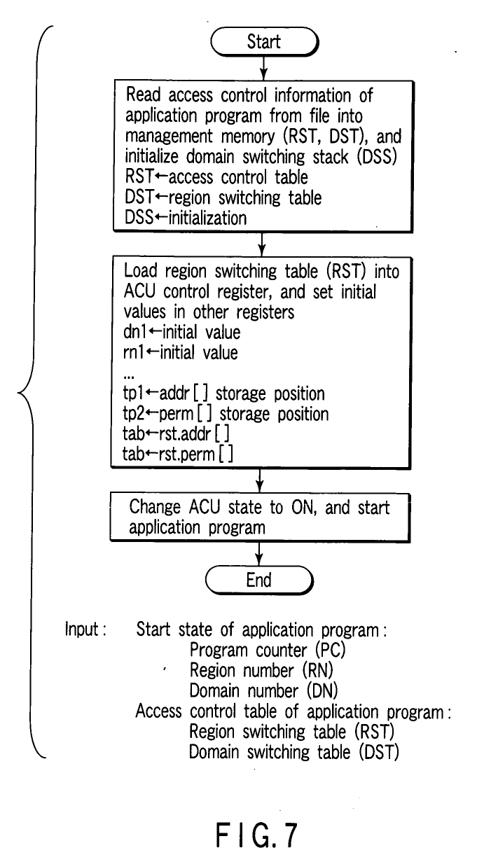

The operation of the access check apparatus will be described next with reference to FIGS. 3, 6, 7, 8, 9, and 10.

As shown in FIG. 2, the access check unit 14 operates upon receiving information from the ACU control register 30 and address VA and operation code OP requested by the processor core, and outputs address ADR, operation code OPC, and exception factor code INT at the time of the occurrence of an exception.

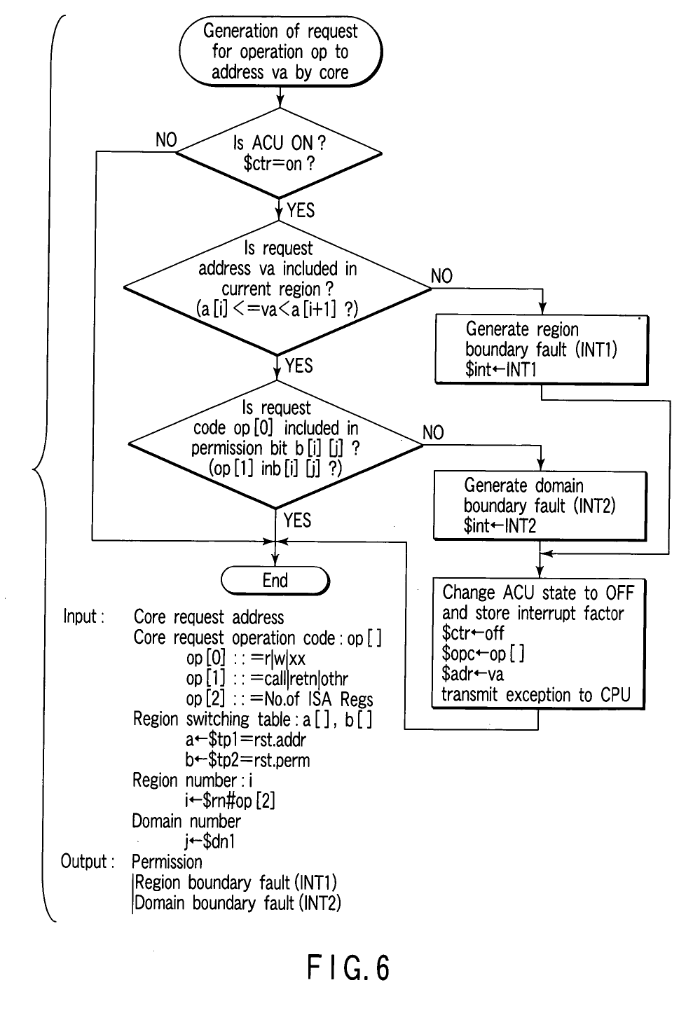

As shown in FIGS. 3 and 6, the access check unit 14 determines an address boundary value from a region number register (RN#), checks whether core request address VA is included in an address boundary, determines a permission bit for the region from the value of the domain number register, and checks whether the region can be accessed. If a failure is determined in the preceding check, an address boundary fault (INT1) generated. If a failure is determined in the subsequent check, a domain boundary fault (INT2) is generated.

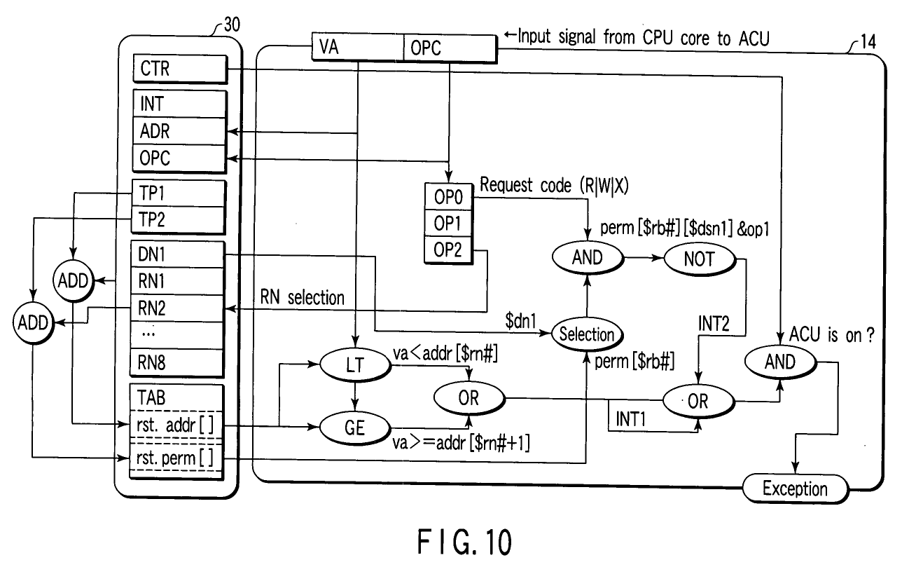

As shown in FIG. 10, the access check unit 14 is implemented as a hardware circuit, and an access violation against the application program is checked in synchronous with a CPU cycle. No processing delay accompanying access check occurs unless a fault is generated.

The access check unit 14 determines permission/inhibition of access before the processor core 11 accesses the main memory 19, only when the control register CTR is ON. The access check unit 14 checks an entry corresponding to region number RN# in the region switching table TP1. If request address VA falls outside the region boundary, a region boundary fault (INT1) is generated. If a permission attribute corresponding to a domain DN1 of the region entry including address VA is checked, and request code OP is not permitted, a domain boundary fault (INT2) is generated. When an exception occurs, request address VA of the instruction which has caused the exception, operation code OP, and the exception factor are stored as ADR, OPC, and INT, respectively. The control register CTR is then turned off, and an interrupt is generated in the processor core 11. The processor core 11 suspends the application program, and starts the management program (region switching device 24 and domain switching device 25). Note that when restoration is made from the management program, the control register CTR is turned on to resume from the instruction address at which the exception has occurred in the application program.

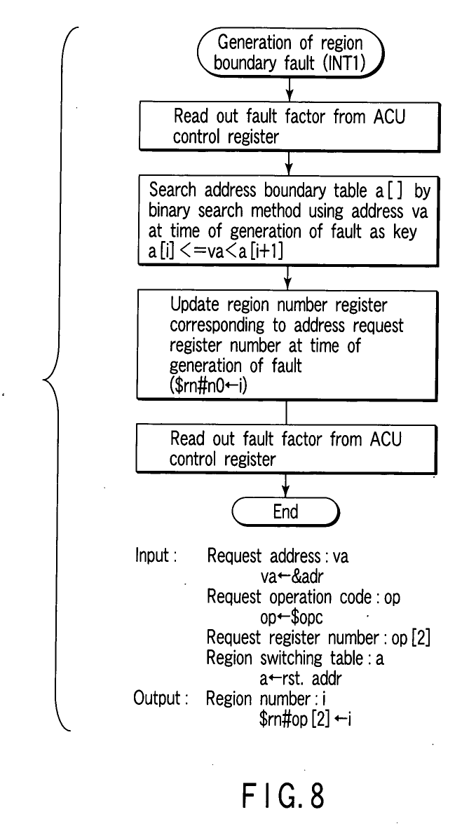

The operation of the region switching device 24 will be described next with reference to FIGS. 3 and 8.

If the memory address requested by the processor core 11 falls outside the region boundary indicated by the current region number, the access check unit 14 generates an address boundary fault (INT1) and switches the processor core 11 to the privileged mode to start a region switching code.

The region switching device 24 is invoked when a factor at the time of the occurrence of an exception is INT1. The region switching device 24 then receives core request address ADR at the time of the occurrence of the exception and the region switching table TP1 of the corresponding process, and outputs new region number RN# including request address ADR. A register in which the region number should be stored is determined by core request operation code OPC and an address register number corresponding to ISA (Instruction Set Architecture) of the processor core 11.

The region switching device 24 searches the region switching table 28 for the region number including request address VA by a binary search method, and sets a new region number in region number register RN#. Thereafter, restoration is made from an exception handler. The processor resumes from the program instruction which has caused an address boundary fault. In an instruction resumed immediately after the execution of the region switching device 24, INT1 does not occur.

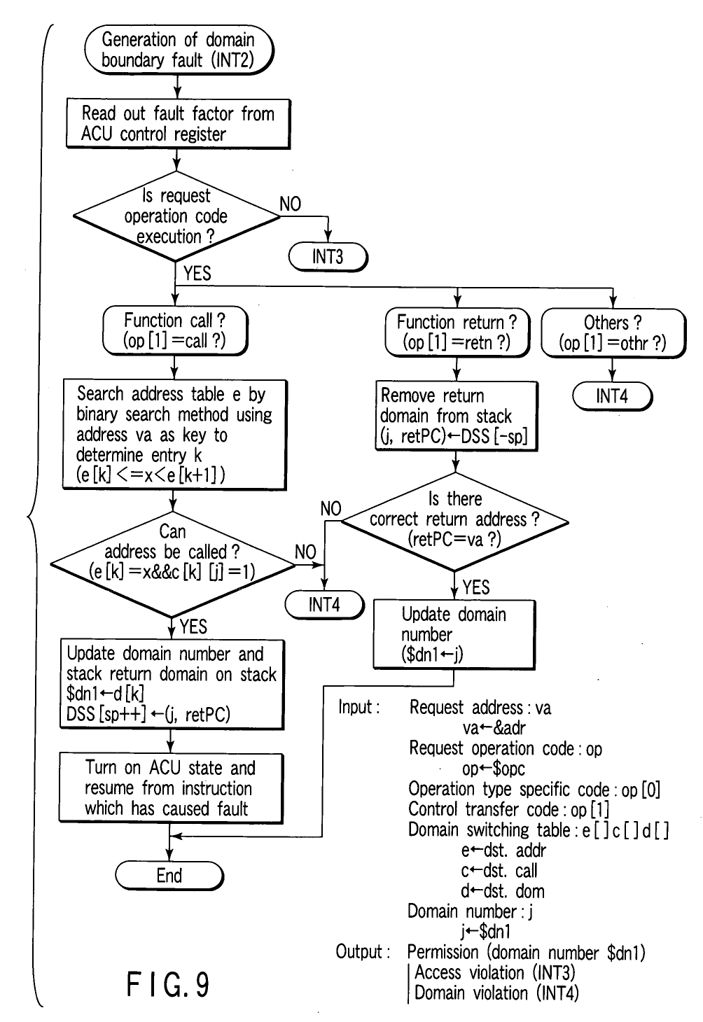

The domain switching device 25 will be described next with reference to FIGS. 3 and 9.

The domain switching device 25 is invoked when a factor code at the time of the occurrence of an exception is INT2. The domain switching device 25 then receives a request address (ADR in FIG. 3) at the time of the occurrence of the exception, the domain switching table 29 (DST) of the corresponding process, the current domain number (DN1 in FIG. 3), and a domain switching stack (DSS), and outputs a new domain number or an exception (INT3 or INT4).

If the type of core request operation code is other than instruction read (op[0]=x), the domain switching device 25 determines an access violation (INT3). Only when the type is instruction read (x), there is a possibility of domain switching. If a control transfer factor is return (op[1]=retn), the domain switching device compares a return address from the domain switching stack 27 (DSS) with a request address. If they coincide with each other, the domain number is switched. If they do not coincide with each other, the domain switching device 25 determines a domain switching violation (INT4).

If the control transfer factor is call (op[1]=call), the domain switching device 25 searches (result k) the domain switching table 29 (DST) using core request address ADR as a key. If an entry point exists (va=e[$dn1]) and is a call permission from the current domain (c[k][$dn1]=1), the domain switching device 25 stacks the current domain number and the function return address in the domain switching stack 27 (DSS), switches the domain to the domain to which the entry point belongs (updates the domain number register DN1), and terminates the management program. The processor then resumes the instruction of the application program which has caused the domain boundary fault.

If a management program for performing recovery control on the corresponding program or the like at the time of the occurrence of an access protection violation (INT3) or domain switching violation (INT4) is registered, control is transferred to the management program for recovery. Otherwise, the program is stopped.

Access locality and tuning will be described next with reference to FIGS. 2, 3, 4, and 10.

Spatial locality in which “a request is also generated for an address near an address requested before” exists in an address sequence requested by the processor during execution of a program. Assume that spatial locality exists. In this case, from the viewpoint of the frequency at which the register value changes, there are tendencies that the change frequency of the domain number register (DN1) is lower than that of the address register, and the change frequency of the region number register (RN#) is lower than that of the domain number register. In addition, the frequency at which the region number is changed is reduced by holding a region number register (RN#) for each address register of the processor core.

In the access control apparatus proposed in FIG. 2, an access check unit is implemented by a hardware circuit as shown in FIG. 10, and an application program is monitored in synchronism with a CPU cycle. For this reason, the control overhead increases only in a portion where a management program is executed at the timing when the address and domain change. Therefore, as the locality of access becomes stronger and the interrupt frequency for the execution of the management program decreases, the overhead accompanying access control decreases. In an extreme case, by defining a single domain and setting all addresses as a single region to allow full access (“rwx”), the program can be executed without generating any overhead.

Changing the granularity of a region and domain as needed makes it possible to give consideration to the tradeoff between reliability and performance. In tuning, it is not necessary to modify a program code itself as an access control target, and it is only necessary to change the access control table in which protection domains are written.

Of the functions necessary for the implementation of the access control apparatus in FIG. 2, only the access check unit 14 used at a high frequency is implemented by a hardware circuit, and the region switching device 24 and the domain switching device 25 which are used at low frequencies at the time of the occurrence of faults are implemented as a management program by software, thereby suppressing the amount of hardware necessary for the implementation of the access control apparatus. This also contributes to reductions in the cost and power consumption of the processor.

On a system on which an operating system exists, the management program is registered as a program for an ACU driver on the operating system. On a system having no operating system, the management program links with an application program.

Assume that an operating system exists. In this case, when a protection target program is read in the user area memory, a corresponding access control table is searched out from a predetermined directory and read in the kernel area. If no corresponding access control table exists, a standard access control table is generated and used. Before the start of the program, the initial values of a region number and domain number are set, and access control on the target program is started.

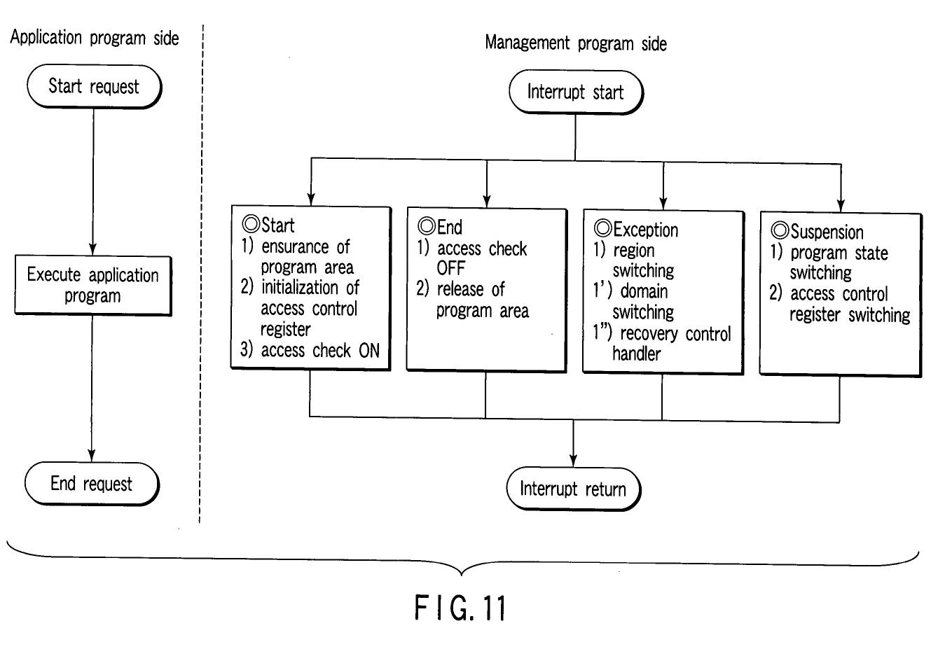

It is assumed that when an application program for a protection target is to be suspended due to the execution of another application program or the like in a system in which an operating system exists, the ACU control register group 30 is saved in the corresponding program management block of the kernel area, and is restored at the time of resumption, as shown in FIG. 11. Note that if the region switching table RST storage area TAB of the ACU control register has a sufficient capacity, RSTs of a plurality of application programs can be simultaneously arranged in the register to realize efficient implementation of switching registers TP1 and TP2 indicating RST heads.

According to the embodiment described above, an access control table reflecting the structure of a program as a protection target is generated, and is registered in a processor before the execution of the program. The processor then sets and switches permission maps by referring to the access control table. This makes it possible to set and switch permission maps regardless of the settings of a program. Therefore, an access memory area for each program component can be efficiently limited.

As another embodiment, a dedicated domain is assigned to an extension (plug-in) code which is executed while dynamically linking with an application program, and an entry point such as a system call which is called by the extension code is individually designated, thereby easily implementing a safe sandbox execution environment for the extension code.

As still another embodiment, when the region switching device 24 is implemented by software, the user of the system can register an executable hook function every time a function at a domain entrance is called, by changing the domain switching code without modifying the original program. Such a hook function is effective in, for example, adding argument check, debugging a program, or storing an operation log.

When an access violation occurs with respect to a component (constituent element) of an application program due to a change of the region switching device 24, registration can be made to call a specific handle code in the program. In such a handle code, for example, recovery control (recovery handler) can be written for each component of an application program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory access control apparatus comprising:
a first storage to store a region switching table in which a plurality of address regions covering a memory space are defined, and operations which can access the regions in a plurality of domains corresponding to components of a program are listed;
a first register to hold an interrupt factor;
a second register to hold a domain number which indicates a domain corresponding to a component of the program under execution;
a third register to hold a region number which indicates a region including an address which is accessed immediately before; and
an access check unit configured to:
receive a processor request address (VA), a processor request operation code (OP), the domain number, and the region number,
issue a first interruption, if the processor request address (VA) falls outside a region boundary which is specified by the region number in the region switching table,
issue a second interruption, if the processor request operation code (OP) is not permitted according to a permission attribute corresponding to the domain number of the region including the processor request address (VA), and
writes a first interrupt factor including the processor request address (VA) and a second interrupt factor including the processor request operation code (OP) in the first register, if the first interruption or the second interruption has been occurred.

2. The apparatus according to claim 1, wherein the region switching table includes a boundary address array (rst.addr[]) in which region boundary addresses are sorted and stored in the order of address values, and wherein a region with a region number i is assumed to be an address area defined by rst.addr[i] or more and less than rst.addr[i+1].

3. The apparatus according to claim 1, wherein the region switching table includes a permission bit map array (rst.perm[]) in which a permission attribute with a region number i is stored as ith element rst.perm[i] in a bitmap format, and a permission attribute with respect to a domain number j is stored as jth slot rst.perm[i][j] of the same bitmap.

4. The apparatus according to claim 1, wherein the first interruption corresponds to an address boundary fault.

5. The apparatus according to claim 4, further comprising:
a region switching device invoked in response to the first interruption, and configured to update the region number in the third register based on the processor request address (VA) of the first interrupt factor stored in the first register, when the address boundary fault has been occurred.

6. The apparatus according to claim 5, wherein the region switching device is implemented by software, and the access check unit is implemented by hardware.

7. The apparatus according to claim 1, wherein the second interruption corresponds to a domain boundary fault.

8. The apparatus according to claim 7, further comprising:
a domain switching table in which a relationship in control transfer between program components is described;
a domain switching device invoked in response to the second interruption, and configured to update the domain number in the second register, or issues a third interruption or a fourth interruption, based on the processor request address (VA) of the first interrupt factor stored in the first register, the processor request operation code (OP) of the second interrupt factor stored in the first register, the domain switching table.

9. The apparatus according to claim 8, wherein the third interruption corresponds to an access violation, and the fourth interruption corresponds to a domain switching violation.

10. The apparatus according to claim 8, wherein the domain switching device is implemented by software, and the access check unit is implemented by hardware.

11. A memory access control method comprising:
storing a region switching table in which a plurality of address regions covering a memory space are defined, and operations which can access the regions in a plurality of domains corresponding to components of a program are listed;
holding an interrupt factor in a first register;
holding a domain number which indicates a domain corresponding to a component of the program under execution in a second register;
holding a region number which indicates a region including an address which is accessed immediately before, in a third register;
receiving a processor request address (VA), a processor request operation code (OP), the domain number, and the region number;
issuing a first interruption, if the processor request address (VA) falls outside a region boundary which is specified by the region number in the region switching table;
issuing a second interruption, if the processor request operation code (OP) is not permitted according to a permission attribute corresponding to the domain number of the region including the processor request address (VA); and
writing a first interrupt factor including the processor request address (VA) and a second interrupt factor including the processor request operation code (OP) in the first register, if the first interruption or the second interruption has been occurred.

12. The method according to claim 11, wherein the region switching table includes a boundary address array (rst.addr[]) in which region boundary addresses are sorted and stored in the order of address values, and wherein a region with a region number i is assumed to be an address area defined by rst.addr[i] or more and less than rst.addr[i+1].

13. The method according to claim 11, wherein the region switching table includes a permission bit map array (rst.perm[]) in which a permission attribute with a region number i is stored as ith element rst.perm[i] in a bitmap format, and a permission attribute with respect to a domain number j is stored as jth slot rst.perm[i][j] of the same bitmap.

14. The method according to claim 11, wherein the first interruption corresponds to an address boundary fault.

15. The method according to claim 14, further comprising:
in response to the first interruption, updating the region number in the third register based on the processor request address (VA) of the first interrupt factor stored in the first register, when the address boundary fault has been occurred.

16. The method according to claim 11, wherein the second interruption corresponds to a domain boundary fault.

17. The method according to claim 16, further comprising:
storing a domain switching table in which a relationship in control transfer between program components is described;
in response to the second interruption, updating the domain number in the second register, or issuing a third interruption or a fourth interruption, based on the processor request address (VA) of the first interrupt factor stored in the first register, the processor request operation code (OP) of the second interrupt factor stored in the first register, the domain switching table.

18. The method according to claim 17, wherein the third interruption corresponds to an access violation, and the fourth interruption corresponds to a domain switching violation.
